(19) United States
(12) Patent Application Publication
(10) Pub. No.: US 2025/0010693 A1
(43) Pub. Date: Jan. 9, 2025

(54) AIR VENT DEVICE AND A VEHICLE INCLUDING THE SAME

(71) Applicants: HYUNDAI MOTOR COMPANY, Seoul (KR); KIA CORPORATION, Seoul (KR); ITW EF&C KOREA LLC., Incheon (KR)

(72) Inventors: Yu Mi Kim, Suwon-si (KR); Yoon Hyung Lee, Seongnam-si (KR); Myung Hoe Kim, Seoul (KR); Byeol Han, Suwon-si (KR); Jin Hu Kim, Anyang-si (KR); Joong Ho Maeng, Incheon (KR); Yong Seok Park, Seoul (KR)

(73) Assignees: HYUNDAI MOTOR COMPANY, Seoul (KR); KIA CORPORATION, Seoul (KR); ITW EF&C KOREA LLC., Incheon (KR)

(21) Appl. No.: 18/509,833

(22) Filed: Nov. 15, 2023

(30) Foreign Application Priority Data
Jul. 4, 2023 (KR) 10-2023-0086168

(51) Int. Cl. B60H 1/34; B60Q 3/20

(52) U.S. Cl. CPC B60H 1/3435; B60Q 3/20; B60H 2001/3471; B60Q 2500/20

(57) ABSTRACT

An air vent device for a vehicle includes an air guide configured to protrude towards a passage through which air flows, wherein a length of the air guide protruding into the passage is adjustable by rotation with respect to the passage.

### CROSS-REFERENCE TO RELATED APPLICATION

This application claims, under 35 U.S.C. § 119 (a), the benefit of and priority to Korean Patent Application No. 10-2023-0086168, filed on Jul. 4, 2023, the entire contents of which are incorporated herein by reference.

### TECHNICAL FIELD

The present disclosure relates to an air vent device for a vehicle.

### BACKGROUND

A vehicle includes an air-conditioning system configured to adjust the quality of air inside the vehicle. For example, the air-conditioning system adjusts the indoor temperature of the vehicle. The air-conditioning system may generate warm air or cool air in order to maintain an appropriate vehicle interior temperature.

As schematically illustrated in FIG. 1, a cabin 10 in a vehicle V may maintain a pleasant environment by a heating, ventilating, air conditioning system 20. Air generated from the heating, ventilating, air conditioning system 20 may be supplied to the cabin 10 through a passage 30. To this end, the cabin 10 includes a discharge port 40 configured to communicate with the passage 30.

The discharge port 40 may have an air vent mounted thereto. Using the air vent, an amount, a direction, etc., of air supplied through the discharge port 40 may be adjusted in the cabin 10. The adjustment function of the air vent is of course important, but the shape of the air vent greatly affects the interior aesthetics of the vehicle. For this reason, recently, a slim or ultra-slim air vent having a very small height to improve indoor aesthetics has been receiving attention. It is more difficult to control the direction and the amount of air in the slim air vent than in a conventional air vent due to its size, and thus research on the structural design of the slim air vent is being actively conducted.

The above information disclosed in this Background section is only for enhancement of understanding of the background of the disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and it is an object of the present disclosure to provide an air vent device capable of effectively controlling the direction of air discharged from a slim air vent, using the Coanda effect.

Another object of the present disclosure is to provide an air vent device capable of securing the amount of air discharged from a slim air vent.

Still another object of the present disclosure is to provide an air vent device in which the direction of air discharged from a slim air vent is recognizable from outside the air vent.

The object of the present disclosure is not limited to the foregoing, and other objects not mentioned herein should be clearly understood by those of ordinary skill in the art to which the present disclosure pertains based on the description below.

The features of the present disclosure to achieve the object of the present disclosure as described above and to perform the characteristic functions of the present disclosure to be described below are as follows.

In one aspect, the present disclosure provides an air vent device including an air guide configured to protrude towards a passage through which air flows. A length of the air guide protruding into the passage may be adjustable by rotation with respect to the passage.

In another aspect, the present disclosure provides an air vent device including an air guide configured to rotate to protrude towards a passage through which air flows, a driving portion configured to provide a driving force to the air guide so that the air guide is rotatable about a pivot axis, and a controller configured to control the operation of the driving portion to adjust the rotation angle of the air guide.

In still another aspect, the present disclosure provides a method of operating an air vent device, the method including: inputting, by an input portion, an air-discharge direction demand for the air vent device: receiving, by a controller, the air-discharge direction demand: computing, by the controller, a position for an air guide of the air vent device based on the air-discharge direction demand; and operating, by the controller, a driving portion of the air guide to move the air guide to the position.

Other aspects and embodiments of the disclosure are discussed below.

It is to be understood that the term “vehicle” or “vehicular” or other similar term as used herein is inclusive of motor vehicles in general, such as passenger automobiles including sport utility vehicles (SUVs), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the disclosure are discussed below.

### BRIEF DESCRIPTION OF THE DRAWINGS

The above and other features of the present disclosure are described in detail below with reference to certain embodiments thereof illustrated in the accompanying drawings which are given hereinbelow by way of illustration only, and thus are not limitative of the present disclosure, and wherein:

FIG. 1 schematically illustrates a heating, ventilating, and air conditioning system of a vehicle:

FIGS. 2 and 3 are cross-sectional views of an air vent device according to an embodiment of the present disclosure, wherein FIG. 2 illustrates a state in which an air guide of the air vent device according to the present disclosure fully protrudes into an air passage, and FIG. 3 illustrates the air guide rotating to move from before protruding to after fully protruding into the air passage:

FIG. 4 is a perspective view of an air vent device mounted to a vehicle according to an embodiment of the present disclosure;

FIG. 5A is a cross-sectional view taken along line A-A of FIG. 4:

FIG. 5B is a partially enlarged view of FIG. 5A:

FIG. 6 is an operation flow chart of an air guide according to some embodiments of the present disclosure:

FIG. 7 illustrates the structure between a first air vent and a second air vent of an air vent device according to some embodiments of the present disclosure;

FIG. 8A illustrates a first air vent and a second air vent when an air vent device according to an embodiment of the present disclosure discharges air upward:

FIG. 8B is a cross-sectional view of the air vent device in the state of FIG. 8A, wherein the arrows indicate the direction of air flow:

FIG. 8C is a front view of the air vent device in the state of FIG. 8A:

FIG. 9A illustrates a first air vent and a second air vent when an air vent device according to an embodiment of the present disclosure discharges air in a straight direction:

FIG. 9B is a cross-sectional view of the air vent device in the state of FIG. 9A:

FIG. 9C is a front view of the air vent device in the state of FIG. 9A:

FIG. 10A illustrates a first air vent and a second air vent when an air vent device according to an embodiment of the present disclosure discharges air downward:

FIG. 10B is a cross-sectional view of the air vent device in the state of FIG. 10A:

FIG. 10C is a front view of the air vent device in the state of FIG. 10A:

FIG. 11 is a cross-sectional view of the related art device:

FIG. 12A illustrates a state in which a protrusion of the device of FIG. 11 fully protrudes, FIG. 12B illustrates a state in which the protrusion of the device of FIG. 11 partially protrudes, and FIG. 12C illustrates a state in which the protrusion of the device of FIG. 11 does not protrude; and

FIG. 12D shows a space that needs to be secured for the operation of the protrusion of FIG. 11.

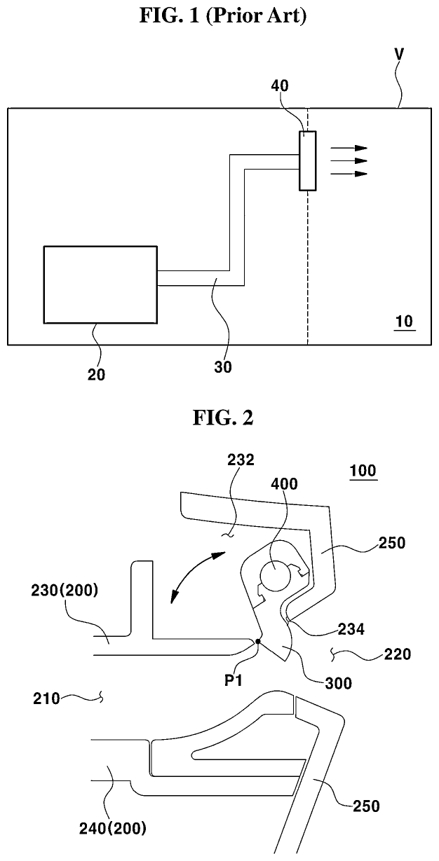

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and usage environment.

In the figures, reference numbers refer to the same or equivalent parts of the present disclosure throughout the several figures of the drawing.

### DETAILED DESCRIPTION

Descriptions of specific structures or functions presented in the embodiments of the present disclosure are merely illustrative for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of embodiments of the present disclosure.

It is understood that when a component is referred to as being “connected to” another component, the component may be directly connected to the other component or intervening components may also be present. In contrast, when a component is referred to as being “directly connected to” another component, there are no intervening components present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

When a component, device, element, or the like of the present disclosure is described as having a purpose or performing an operation, function, or the like, the component, device, or element should be considered herein as being “configured to” meet that purpose or to perform that operation or function.

Hereinafter, the present disclosure is described in detail with reference to the accompanying drawings.

An air vent device according to the present disclosure is configured to control the direction of air discharged therefrom using the Coanda effect. Specifically, the direction of air flow is controlled by an air guide protruding into an air passage. In this example, the air guide is configured to rotate to protrude into the passage.

As illustrated in FIG. 2, an air vent device 100 may include a housing 200. The housing 200 defines a passage 210 configured to transfer air from a heating, ventilating, and air conditioning (HVAC) system 20 of a vehicle V to a cabin 10 of the vehicle V. The air may flow through the passage 210 from the HVAC system 20, and the air may be supplied to the cabin 10 through a discharge port 220.

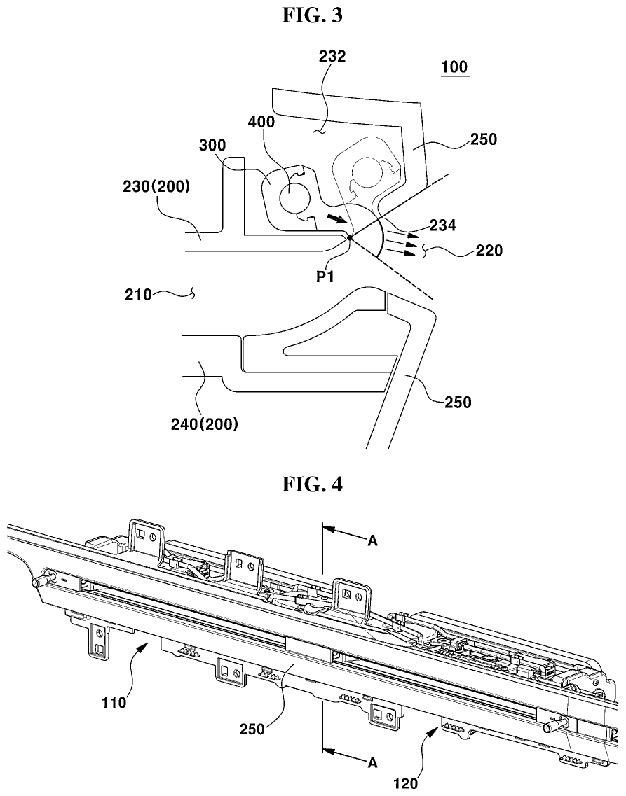

Referring to FIG. 3, the air vent device 100 includes an air guide 300. The air guide 300 is configured to rotate with respect to the passage 210. The air guide 300 may rotate to protrude into the passage 210. For example, the air guide 300 may rotate about a pivot axis P1 formed at the housing 200 (i.e., at a location of, on, or in the housing 200) or at an upper portion 230 of the housing 200. Using the Coanda effect, the direction of air or wind discharged through the discharge port 220 may be controlled along the length of the air guide 300 protruding into the passage 210. The air guide 300 may be rotatable about the pivot axis P1 by a known method or the like. For example, the air vent device 100 includes a driving portion 302. The air guide 300 may rotate about the pivot axis P1 by the operation of the driving portion 302. As a non-limiting example, the driving portion 302 may be an electric motor.

In some embodiments, the air guide 300 may be mounted at the upper portion 230 of the housing 200. In some embodiments, unlike the drawing, the air guide 300 may be mounted at a lower portion 240 of the housing 200.

The air guide 300 may be disposed in a space 232 provided at the upper portion 230 of the housing 200. For example, the space 232 may be defined by the upper portion 230 and a garnish 250 which is coupled to an external side of the upper portion 230 of the housing 200. As another example, the space 232 may be defined by the shape of the upper portion 230 of the housing 200.

The housing 200 may define an opening 234. In some embodiments, the opening 234 may be defined by the housing 200 and the garnish 250. The opening 234 allows the air guide 300 disposed outside the housing 200 or disposed in the space 232 to protrude into the passage 210.

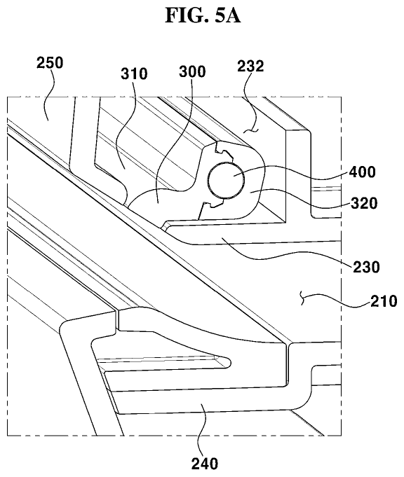

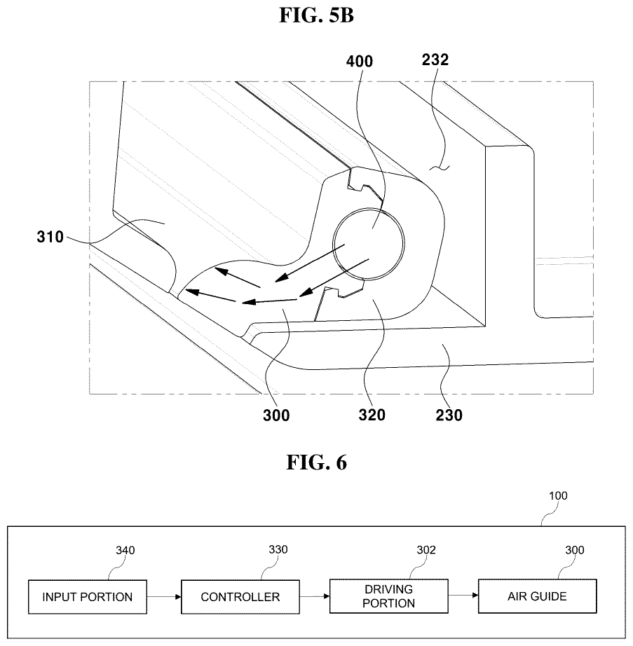

Referring to FIGS. 4, 5A, and 5B, the air guide 300 may include a light-emitting region 310. The light-emitting region 310 is configured to emit light. Particularly, the light-emitting region 310 may be provided on the air guide 300, so that when the air guide 300 protrudes into the passage 210, light from the light-emitting region 310 is recognized at the discharge port 220 or at the cabin 10 (i.e., from the cabin 10 or in the cabin 10). In some embodiments, the air guide 300 may include a curved portion, and the light-emitting region 310 may be provided in or on the curved portion.

According to an embodiment of the present disclosure, the air vent device 100 includes a light string 400 and a light-emitting diode (LED) module 500. The light string 400 and the LED module 500 allow the air guide 300 to emit light.

The light string 400 may be mounted in the air guide 300. The light string 400 may be an optical fiber that implements line lighting by allowing light from the LED module 500 to pass therethrough.

In some embodiments, the air guide 300 may be made of a transparent material. As a non-limiting example, the air guide 300 may be made of polycarbonate (PC). The light-emitting region 310 may be coated with light-transmissive paint. A non-light-emitting region, which is a region on the air guide 300 excluding the light-emitting region 310, may be shield coated. Therefore, as illustrated in FIG. 5B, light may pass only through the light-emitting region 310 in the direction of the arrows, and the size of the light-emitting region 310 recognized from outside (e.g., from the cabin 10) may change depending on the rotation angle of the air guide 300, allowing the light to be recognizable by eyesight.

In some embodiments, the air guide 300 may further include a cover 320. The cover 320 may surround the light string 400 mounted in the air guide 300. In some embodiments, the cover 320 may be integrated with the air guide 300.

Referring to FIG. 6, in some embodiments, the air vent device 100 may further include a controller 330. The controller 330 may receive a position demand for the air guide 300 or an air-discharge direction demand for the air vent device 100 requested by a user to thereby rotate the air guide 300 based on the position demand or the air-discharge direction demand.

The controller 330 may collect position demand information for the air guide 300 requested by the user through an input portion 340. The input portion 340 may be a switch or a knob configured to adjust the rotation angle of the air guide 300. The input portion 340 may be provided in the air vent device 100 itself, or may be provided remotely from the air vent device 100 to communicate with the air vent device 100 or with the controller 330. In an embodiment, the input portion 340 may be a mechanical switch communicatively connected to the controller 330. In another embodiment, the input portion 340 may be an icon-type switch on a touch screen of an electronic device communicatively connected to the controller 330.

The controller 330 may operate the driving portion 302 based on the position demand information for the air guide 300 or the air-discharge direction demand requested by the user. The driving portion 302 may rotate the air guide 300 about the pivot axis P1 according to the command of the controller 330 so that air is discharged in a direction requested by the user.

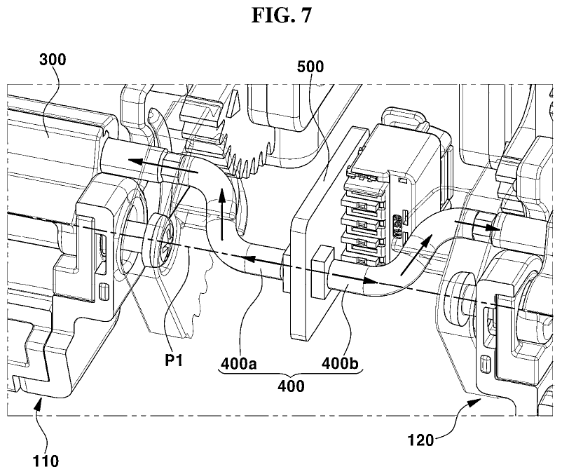

As illustrated in FIG. 7, according to the present disclosure, one LED module 500 may supply light to the light-emitting region 310 of at least two air vents. For example, referring back to FIG. 4, when a first vent 110 and a second vent 120 are present that are separated from each other, the LED module 500 is disposed between the first vent 110 and the second vent 120. The light string 400 is connected to the LED module 500 and is configured to pass through both the first vent 110 and the second vent 120. Accordingly, light from the LED module 500 may pass through a light string 400a passing through the first vent 110 and a light string 400b passing through the second vent 120. Therefore, according to the present disclosure, only one LED module 500 is needed, thereby improving space utilization and reducing costs.

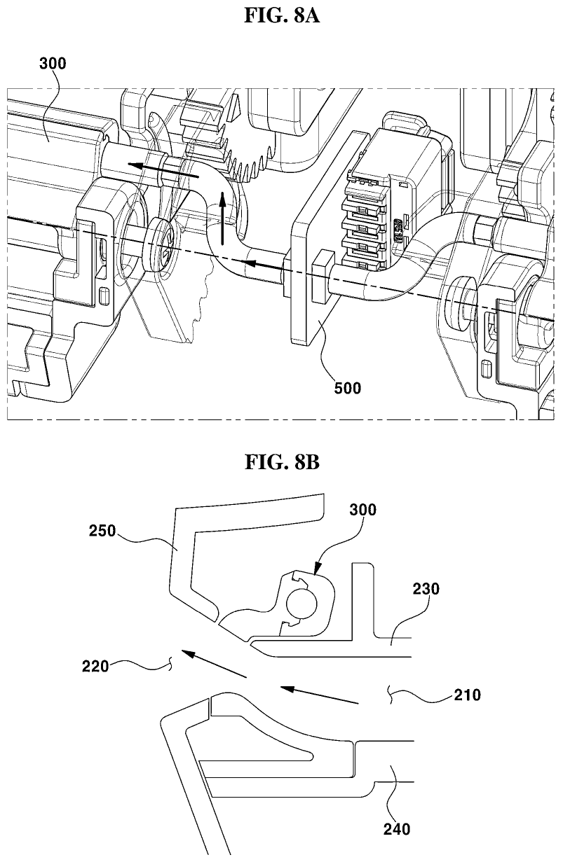

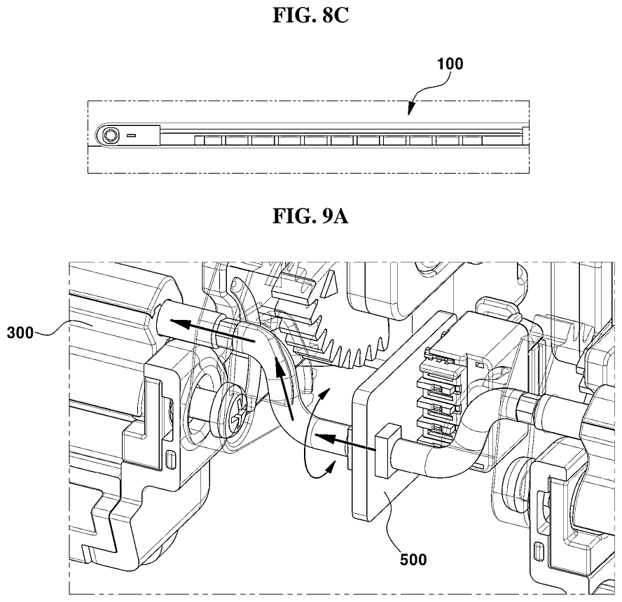

FIGS. 8A, 9A, and 10A illustrate a first position, a second position, and a third position of the air guide 300, respectively, changing as the air guide 300 rotates.

When the air guide 300 is in the first position as illustrated in FIG. 8A, the rotation angle of the air guide 300 is 0° as illustrated in FIG. 8B. Because the air guide 300 in the first position does not protrude into the passage 210, air flowing through the passage 210 is discharged upward along the passage 210 as indicated by the arrows. As illustrated in FIG. 8C, the light-emitting region 310 is not observed from the cabin 10 because the rotation angle of the air guide 300 in the first position is 0°, and it is easily recognized that the air is discharged upwards.

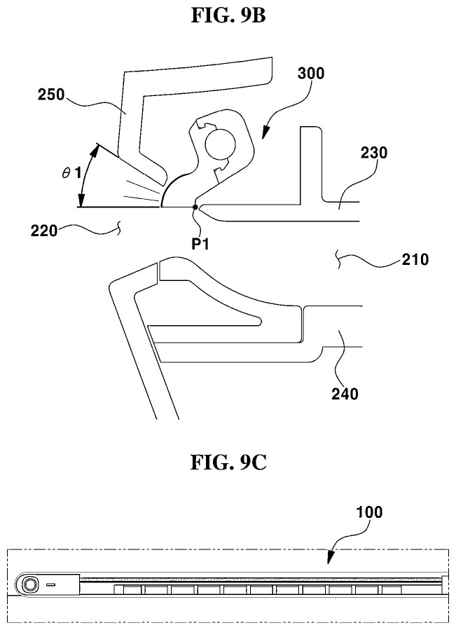

When the air guide 300 is in the second position as illustrated in FIG. 9A, the air guide 300 is rotated by a predetermined angle θ1 as illustrated in FIG. 9B. For example, the rotation angle θ1 may be about 35°. In the second position, the air guide 300 is rotated so that a portion thereof is parallel with a horizontal direction or to be flush with the upper portion 230 of the housing 200 to allow air flowing through the passage 210 to be discharged through the discharge port 220 in a straight direction. As illustrated in FIG. 9C, when the air guide 300 is in the second position, a part of the light-emitting region 310 is exposed to the discharge port 220, and thus the light from the light-emitting region 310 may be observed from the cabin 10. Because only a part of the light-emitting region 310 is observed, it can be immediately recognized from the cabin 10 that air is being discharged in the straight direction.

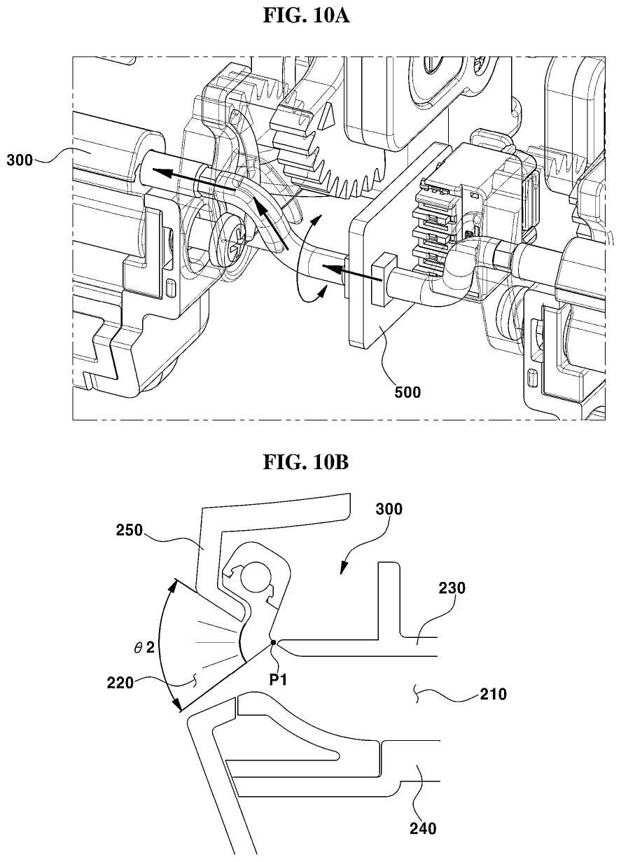

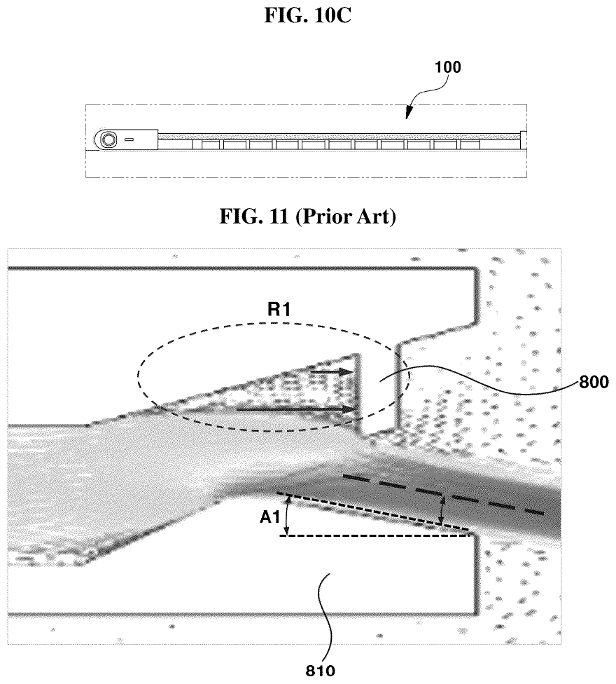

When the air guide 300 is in the third position as illustrated in FIG. 10A, the air guide 300 is fully rotated as illustrated in FIG. 10B and air may be discharged downward. In this example, the air flowing through the passage 210 may hit the air guide 300 protruding into the passage 210 and then be diverted downward. For example, a rotation angle θ2 of the air guide 300 may be about 70°. As illustrated in FIG. 10C, the area of the light-emitting region 310 exposed to the passage 210 when air guide 300 is in the third position increases compared to the same when the air guide 300 is in the second position, and thus the area of the light-emitting region 310 observed from the cabin 10 increases in size. As such, the present disclosure has the advantage of enabling immediate recognition of the discharge direction of air and improving space utilization, which is described in detail below.

In the related art, an air vent using the Coanda effect has been introduced. Referring to FIG. 11, according to the related art, a protrusion 800 moves linearly to protrude into a passage defined by a housing 810. However, there was a problem in that as the protrusion 800 protrudes and increases in length, a vortex is generated at a portion where air comes into contact with the protrusion 800 (R1 in FIG. 11). Such a vortex area may be reduced using the air guide 300 of the present disclosure configured to protrude in a rotating manner. In an experiment performed on both the related art air vent and the air vent of the present disclosure under the same conditions, it was confirmed that the air volume was improved by more than 50% in the air vent of the present disclosure.

In the related art, the downward discharge of air was controlled using an angle A1 of a lower portion of the housing 810 and by projecting the protrusion 800 to the maximum to divert the direction of air flow. The present disclosure is advantageous in that the downward discharge of air may be controlled at an angle larger than the angle A1 because the rotation angle of the air guide 300 is used instead of the angle A1 of the lower portion of the housing 810. In the experiment, it was confirmed that the angle A1 in the related art was about 10°, whereas in the present disclosure, the air directed downward was discharged at an angle of about 37°.

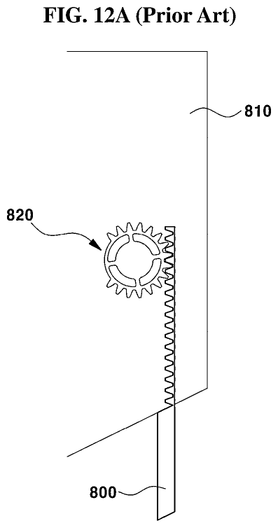

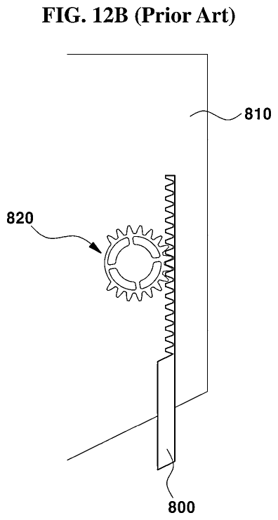

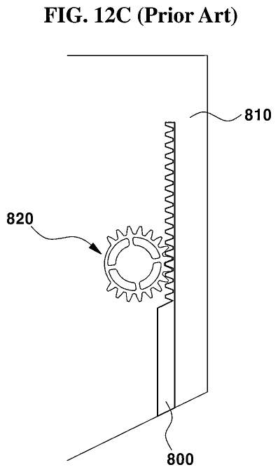

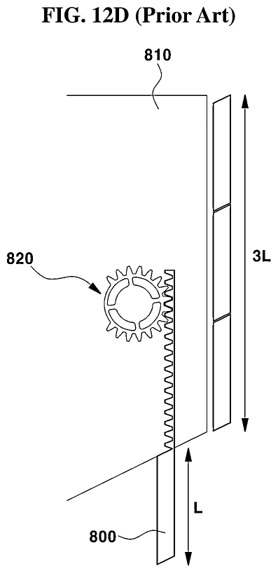

According to the related art, the protrusion 800 requires a relatively large space outside the housing 810 because the protrusion 800 protrudes using a linear moving device 820, such as a rack and pinion gear system. As illustrated in FIGS. 12A-12C, in order to discharge the air downward, in a straight direction, or upward by the linear movement of the protrusion 800, a space three times a length L of the protrusion 800 is needed. However, the air guide 300 of the present disclosure is controlled in a rotating manner, reducing the required space for operating the same and improving space utilization. In the experiment, it was confirmed that the required space was reduced by about 30% compared to the related art.

According to the present disclosure, the air vent device is improved in controlling the amount and the direction of air flow.

According to the present disclosure, the rotatable air guide may greatly reduce an internal space that is required.

According to the present disclosure, the direction of air currently being discharged may be easily recognized from outside the air vent because the air guide includes the light-emitting region.

As is apparent from the above description, the present disclosure provides the following effects.

According to the present disclosure, there is proposed a slim air vent device capable of effectively controlling the direction of air discharged therefrom using the Coanda effect.

According to the present disclosure, there is provided a slim air vent device capable of securing the amount of air discharged therefrom.

According to the present disclosure, there is provided a slim air vent device in which the direction of air discharged therefrom is recognizable from outside the air vent.

Effects of the present disclosure are not limited to what has been described above, and other effects not mentioned herein should be clearly recognized by those having ordinary skill in the art based on the above description.

It should be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. An air vent device comprising:
an air guide configured to protrude toward a passage through which air flows,
wherein a length of the air guide protruding into the passage is adjustable by rotation with respect to the passage.

2. The air vent device of claim 1, wherein the air guide is configured to be rotatable between a first position, a second position, and a third position.

3. The air vent device of claim 2, wherein:
when the air guide is in the first position, the air flowing through the passage is discharged along the passage in a first direction;
when the air guide is in the second position, the air flowing through the passage is discharged in a second direction, which is a horizontal direction; and
when the air guide is in the third position, the air flowing through the passage is discharged in a third direction, wherein each of the first direction and the third direction forms a different angle with respect to the second direction.

4. The air vent device of claim 3, wherein the air guide, in the first position, does not protrude into the passage.

5. The air vent device of claim 3, wherein the air guide, in the second position, partially protrudes into the passage.

6. The air vent device of claim 3, wherein the air guide, in the third position, fully protrudes into the passage.

7. The air vent device of claim 1, wherein the air guide comprises a light-emitting region configured to emit light.

8. The air vent device of claim 7, wherein an area of the light-emitting region exposed to the passage increases in size as the air guide protrudes into the passage.

9. The air vent device of claim 7, wherein the air guide comprises a light source configured to supply light to the light-emitting region.

10. The air vent device of claim 9, wherein the light source comprises:
a light string mounted in the air guide and formed of an optical fiber; and
an LED module connected to the light string and configured to supply light to the light string.

11. The air vent device of claim 7, wherein:
the air guide is made of a transparent material;
the light-emitting region is coated with light-transmissive paint; and
a non-light-emitting region, which is a region on the air guide excluding the light-emitting region, is shield coated.

12. The air vent device of claim 7, wherein the light-emitting region is provided on the air guide and faces a discharge port through which the air is discharged from the passage.

13. The air vent device of claim 1, wherein:
the passage is defined by a housing; and
the air guide is rotatable about a pivot axis arranged at the housing.

14. The air vent device of claim 1, wherein the air guide is provided adjacent to a discharge port through which the air is discharged from the passage.

15. An air vent device comprising:
an air guide configured to rotate to protrude toward a passage through which air flows;
a driving portion configured to provide a driving force to the air guide so that the air guide is rotatable about a pivot axis; and
a controller configured to control an operation of the driving portion to adjust a rotation angle of the air guide.

16. The air vent device of claim 15, further comprising an input portion configured to input a position demand for the air guide and to communicate with the controller,
wherein the controller operates the driving portion based on the position demand input by the input portion.

17. A method of operating an air vent device, the method comprising:
inputting, by an input portion, an air-discharge direction demand for the air vent device;
receiving, by a controller, the air-discharge direction demand;
computing, by the controller, a position for an air guide of the air vent device based on the air-discharge direction demand; and
operating, by the controller, a driving portion of the air guide to move the air guide to the position.

18. The method of claim 17, wherein the air guide is configured to rotate to protrude into a passage in the air vent device through which the air flows.
